(19) United States
(12) Patent Application Publication
(10) Pub. No.: US 2017/0258672 A1
(43) Pub. Date: Sep. 14, 2017

(54) MITT FOR COMPRESSION GARMENTS

(71) Applicant: Tactile Systems Technology, Inc., Minneapolis, MN (US)

(72) Inventors: Darren Jay Wennen, Edina, MN (US); Daniel G. Chase, Menomonie, WI (US); Kristian Dior Gamble, Minneapolis, MN (US)

(21) Appl. No.: 15/411,003

(22) Filed: Jan. 20, 2017

Related U.S. Application Data
(60) Provisional application No. 62/305,951, filed on Mar. 9, 2016.

(51) Int. Cl. A61H 9/00; A61H 1/00

(52) U.S. Cl. CPC A61H 9/0078; A61H 9/0092; A61H 1/008; A61H 2201/1238; A61H 2201/1619; A61H 2201/1635

(57) ABSTRACT

A wraparound portion of compression garments may include a mitt defining a mitt opening. A user may place their hand in the mitt opening of the mitt to assist in donning the compression garments about their body. For example, the wraparound portion of the compression garment may be located in awkward position for a human user to grasp, and the mitt and mitt opening may assist a user in grasping and moving the wraparound portion about their body.

This application claims the benefit of U.S. Provisional Application No. 62/305,951, filed Mar. 9, 2016, the disclosure of which is incorporated by reference herein in its entirety.

The present disclosure relates generally to compression garments including a mitt and methods to don, or put on, such compression garments. Once donned, the compression garments may apply pressure to one or more regions of a portion of a body such as, e.g., arm regions, shoulder regions, torso regions, and neck regions.

Various types of compression garments are available such as for treatment of lymphedema, edema, wound healing, etc. For example, garments may include inflatable chambers or cells (or other actuatable elements) to provide therapy to patients and may be positioned about various body portions of a person or animal. Specifically, the garments may be positioned about body portions that exhibit swelling due to a build-up of lymph and that would benefit from compression therapy provided by the garments. For example, such chambers or cells may be inflatable to one or more different pressures in a variety of sequences to provide the therapy to the patient by moving lymph from one region to another. In other words, such compression garments may be placed around at least a portion of an individual's body for use in applying pressure to the body at an affected extremity. These compression garments may be donned (e.g., put on) and doffed (e.g., taken off) by patients themselves or with help from others.

### SUMMARY

One exemplary method of donning a compression garment on a user may include providing an exemplary compression garment. One exemplary compression garment may include an arm portion defining an arm opening to receive at least a portion of a first arm of a user to apply compression to the first arm, and a wraparound portion extending from a proximal end region coupled to the arm portion and terminating a distal end region. The wraparound portion may include a mitt at distal end region defining a mitt opening to receive a hand of a second arm of the user to assist the user in inserting the first arm into the arm opening of the arm portion and in wrapping the wraparound portion around a posterior torso region to an anterior torso region of the user. The exemplary method may further include inserting the first arm of the user into the arm opening of the arm portion of the compression garment and inserting the hand of the second arm of the user into the mitt opening of the mitt portion. The exemplary method may further include moving, when the hand of the second arm is inserted into the mitt opening, the hand of the second arm of the user in a direction away from the first arm to assist in inserting the first arm further into the arm opening of the arm portion and moving, when the hand of the second arm is inserted into the mitt opening, the hand of the second arm of the user across the anterior torso region of the user to wrap the wraparound portion around the posterior torso region to the anterior torso region of the user.

In one or more embodiments, the mitt opening may be sized to receive more than the fingers of the hand of the second arm of the user. In one or more embodiments, the mitt opening may be open in a direction opposite the location of the arm portion when the wraparound portion is wrapped around the posterior torso region to the anterior torso region of the user.

In one or more embodiments, the compression garment may further include a torso portion coupled to the proximal end region of the wraparound portion and coupled to the arm portion. The distal end region of the wraparound portion may be removably couplable (e.g., using hook-and-loop fasteners) to the torso portion of the compression garment.

In one or more embodiments, the torso portion may include a plurality of pressure applying regions to apply pressure to a plurality of torso regions of the torso of the user when the compression garment is donned to assist in moving lymph from the torso to one or more axillary nodes. Further, in one or more embodiments, the torso portion may be configured to be grasped by the hand of the second arm of the user to assist inserting the first arm into the arm opening of the arm portion prior to the use of the mitt opening to assist in inserting the first arm further into the arm opening of the arm portion. For example, the torso portion may include a loop segment that is configured to be grasped by the hand of the second arm of the user to assist inserting the first arm into the arm opening of the arm portion prior to the use of the mitt opening to assist in inserting the first arm further into the arm opening of the arm portion. In one or more embodiments, the arm portion may extend from a first end region to a second region coupled to the wraparound around portion. The first end region may be configured to be located proximate the arm pit of the first arm and the second end region may be configured to be located proximate the hand of the first arm when the compression garment is donned. Further, the arm portion may define a plurality of arm pressure applying regions positioned along the arm portion from first end region to the second region to apply pressure to a plurality of arm regions of the first arm to assist in moving lymph from the first arm to one or more axillary nodes when the compression garment is donned. Still further, the arm portion of the compression garment may include a plurality of cells corresponding to the plurality of arm pressure applying regions and configured to receive fluid to apply pressure to the plurality of regions of the first arm when the compression garment is donned.

In one or more embodiments, the wraparound portion of the garment further may include a plurality of pressure applying regions to apply pressure to a plurality of torso regions of the torso of the user to move lymph from the torso to one or more axillary nodes.

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF THE DRAWINGS

FIG. 1A is a diagrammatic view of an exemplary compression garment including a wraparound portion having a mitt.

FIG. 1B is a plan view of an exemplary compression garment including torso portion and a wraparound portion having a mitt.

FIG. 2 is a diagram of a hand for use in describing the mitt of FIGS. 1A-1B.

FIG. 3 is a perspective view of a user inserting their left arm in an arm portion of an exemplary compression garment including a wraparound portion having a mitt.

FIG. 4 is a front perspective view of the user further inserting their left arm into the arm portion of the exemplary compression garment of FIG. 3.

FIG. 5 is a rear perspective view of the user further inserting their left arm into the arm portion of the exemplary compression garment of FIG. 3 using the mitt.

FIG. 6 is a front perspective view of the user wrapping the wraparound portion of the exemplary compression garment of FIG. 3 around their torso using the mitt.

FIG. 7 is a front perspective view of the user and the exemplary compression garment of FIG. 3 after donning the compression garment.

FIG. 8 is an exploded perspective view of the exemplary compression garment of FIGS. 3-7.

### DETAILED DESCRIPTION OF EXEMPLARY EMBODIMENTS

In the following detailed description of illustrative embodiments, reference is made to the accompanying figures of the drawing, which form a part hereof, and in which are shown, by way of illustration, specific embodiments which may be practiced. It is to be understood that other embodiments may be utilized and structural changes may be made without departing from (e.g., still falling within) the scope of the disclosure presented hereby.

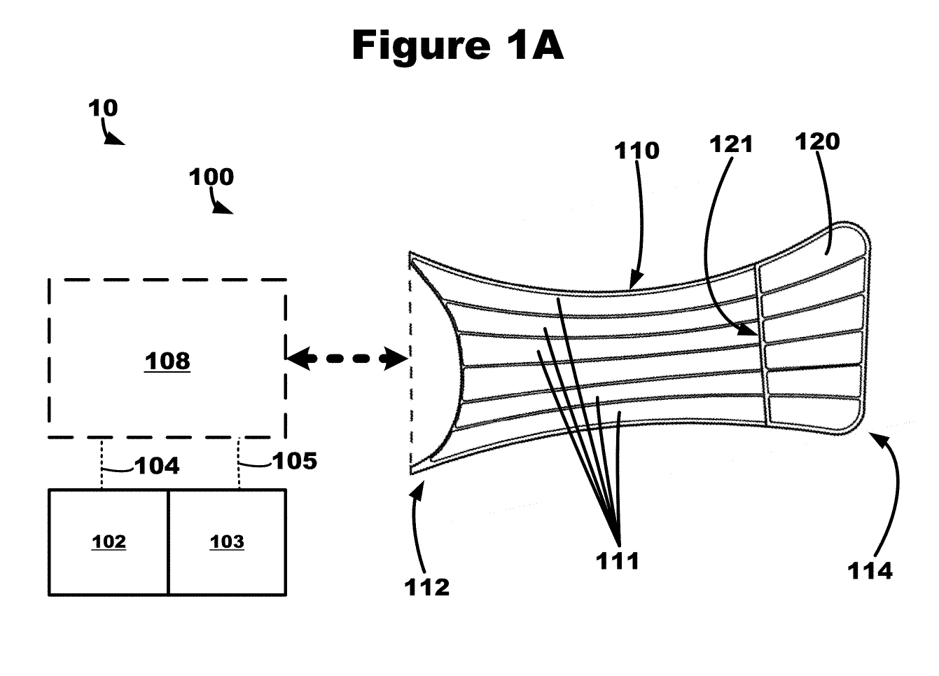

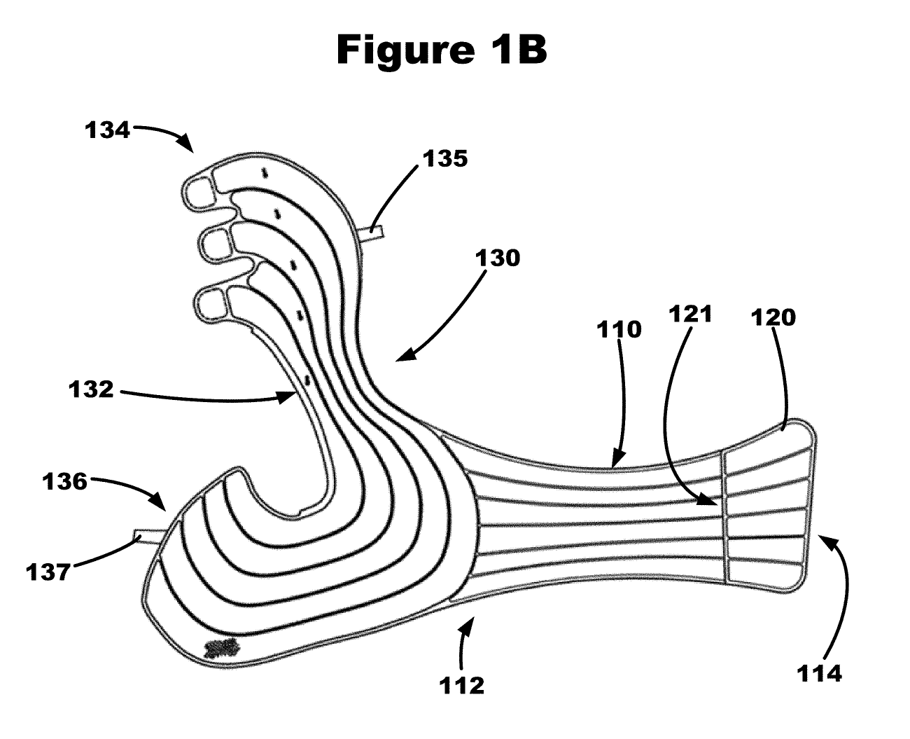

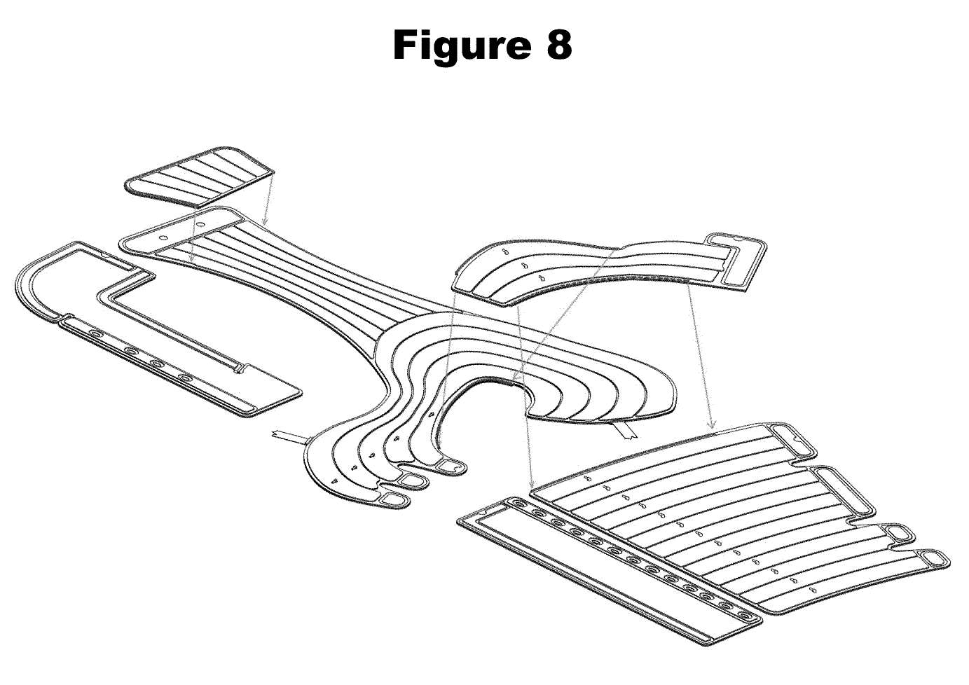

Exemplary apparatus, structures, and methods shall be described with reference to FIGS. 1-8. It will be apparent to one skilled in the art that elements from one embodiment may be used in combination with elements of the other embodiments, and that the possible embodiments of such apparatus, structures, and methods using combinations of features set forth herein is not limited to the specific embodiments shown in the Figures and/or described herein. Further, it will be recognized that the embodiments described herein may include many elements that are not necessarily shown to scale. Still further, it will be recognized that the size and shape of various elements herein may be modified but still fall within the scope of the present disclosure, although certain one or more shapes and/or sizes, or types of elements, may be advantageous over others.

The present disclosure relates generally to compression garments and systems that include garment portions that are configured to be donned on at least a portion of a body (e.g., person, animal, etc.) and configured to apply pressure to that portion of the body, and methods using such compression garments and systems (e.g., methods of donning a garment, methods of controlling pressure applied to the body, etc.)

Compression garment systems (e.g., such as compression garments described in U.S. Pat. No. 6,179,796 entitled “Lymphedema treatment system,” U.S. Pat. No. 6,645,165 entitled “Lymphedema treatment system,” U.S. Pat. No. 6,860,862 entitled “Lymphedema Treatment System,” U.S. Pat. No. 6,966,884 entitled “Lymphedema Treatment System,” and U.S. Provisional Pat. App. Ser. No. 62/281,706 filed on Jan. 21, 2016 and entitled “Compression Garment System,” each of which is herein incorporated by reference in their entireties and which may modify and be modified with features described herein) may be used for various reasons including therapy for people with lymphedema, animals requiring therapy, wound therapy, etc. As used herein, the term body refers to not only humans but any other animal species that may benefit from the concepts and features described herein. These compression garments may be placed around at least a portion of an individual's body and used to apply pressure to the body at an affected extremity (e.g., head, neck, arm, torso, a shoulder, etc.). Some embodiments described herein may include a compression system having a garment configured to be positioned on (e.g., wrapped around, placed adjacent, located in proximity to, etc.) at least a portion of a body (e.g., human body, arm, torso, a shoulder, head, neck, etc.). The compression garments may be donned (e.g., put on) and doffed (e.g., taken off) by individuals themselves or with help from others. The garment may also include one or more chambers (e.g., cells, compartments, sealed volumes, bladders etc.) distributed (e.g., distributed throughout, distributed in concentric patterns “radiating” away from a central point or axis, along a length, etc.) of the garment configured to receive a fluid (e.g., air) to perform compression therapy.

The compression therapy provided by the compression garment systems may help to treat lymphedema. Lymphedema is a condition of localized fluid retention and tissue swelling that may be inherited, caused by cancer treatments, caused by parasitic infections, injury, etc. Compression garments described herein covering the head and neck may be used by an affected individual to provide a therapeutic benefit. Specifically, the compression garments may be configured to manipulate lymph nodes or vessels by applying pressure to move lymph toward more beneficial locations (e.g., toward drainage areas, away from affected regions, etc.). For example, compression therapy using the garments and systems described herein may be performed around the arm and torso regions, or areas, to help treat lymphedema in the arm and torso by, e.g., moving lymph towards various lymph collection areas in the torso.

The compression garments described herein may be configured to apply pressure to the affected regions of the body to apply compression therapy. The compression garments may include various portions that each includes controllable pressure applying regions. Each controllable pressure applying region may be configured to apply pressure to a specific portion of the body (e.g., at a specific time during therapy). The controllable pressure applying regions may work in combination with one another to help provide therapy by applying a sequence of pressures on the body that moves lymph in a desired direction (e.g., from the hands down the arms towards the torso, from one or more regions of the torso to lymph collection regions of the torso, etc.). Such application of a sequence of pressures on the body that moves lymph (e.g., pressure being applied to one or more portions of the arm, shoulder, and torso at different times during a compression therapy period) may be referred to as applying dynamic pressure to the body. The sequence of pressures may be referred to as a pressure gradients, e.g., from a distal region to a proximal region. Additionally, in some embodiments, dynamic pressure may not be applied sequentially, and instead, be applied non-sequentially as will be further described herein.

The controllable pressure applying regions of the compression garments may also apply static pressure to the body. For example, the compression garments may apply a constant pressure when a portion of the garment is positioned on the body over a therapy time period (e.g., static pressure over the therapy time period) or may apply a pressure that may be controlled to change over time during the therapy time period (e.g., dynamic pressure). In one or more embodiments, the dynamic pressure may be applied to the portion of the body through one or more chambers in the compression garment. The one or more chambers may be configured to receive fluid (e.g., air). Alternately, or in combination with one or more fluid receiving chambers, such pressures may be applied using one or more actuatable elements in the compression garment configured to apply pressure to the body (e.g., electrically controlled materials suitable to provide compression).

An exemplary compression garment system 10 including a controller 102, a pump 103, and a garment 100 (e.g., a compression garment) configured to be positioned around at least a portion of a body, e.g., a human body or at least a portion of a human body, is shown in FIG. 1A. The controller, or control processor, 102 may be configured to control the pressure applied to one or more regions or portions of a user's body using the garment 100. For example, the controller 102 may control the pressure applied to each region or portion of the user's body using a plurality of individual controlled, independent pressure applying regions of the garment 100. Further, for example, pressure applying regions of the garment 100 may be controlled in groups or combinations. In one or more embodiments, the controller 102 may be configured to control the pressure applying regions in a variety of different sequences (e.g., applying pressure in a predetermined manner) that may be, e.g., suitable for carrying out lymphedema therapy.

Further, the controller 102 may control the pressure based on one or more pressures measured by one or more pressure sensors associated with the garment 100 (e.g., sensors provided in the garment 100 proximate the pressure applying regions) or with other portions of the system 10 (e.g., sensors in communication with the mpumt, conduits, filling chambers or cells, etc.) One or more compression garments that may be modified with features (e.g., sensors) described herein may be similar to and include one or more features found in U.S. Pat. No. 6,860,862 entitled “Lymphedema Treatment System,” U.S. Pat. No. 6,966,884 entitled “Lymphedema Treatment System,” U.S. Pat. No. 6,179,796 entitled “Lymphedema treatment system,” U.S. Pat. No. 6,645,165 entitled “Lymphedema treatment system,” U.S. Pat. No. 9,027,408 entitled “Elastomeric Particle Having An Electrically Conducting Surface, A Pressure Sensor Comprising Said Particles, A Method For Producing Said Sensor And A Sensor System Comprising Said Sensors,” and U.S. Pat. No. 7,947,003 entitled “Pressurized Medical Device,” each of which is incorporated by reference in their entireties.

In one or more embodiments, the controller 102 (e.g., one or more processors employing one or more programs or routines carrying out one or more methods or processes and implemented with one or more types of memory) may be configured to control the system and/or one or more elements thereof (e.g., providing compression therapy by the one or more pressure applying regions, etc.). In one or more embodiments, the controller, or control processor, 102 may be configured to control the compression system using wired and/or wireless technology.

The methods and/or logic and/or configurations described in this disclosure, including those attributed to the systems, or various constituent components, may be implemented, at least in part, in hardware, software, firmware, or any combination thereof. For example, various aspects of the techniques may be implemented within one or more processors, including one or more microprocessors, microcontrollers, DSPs, ASICs, FPGAs, or any other equivalent integrated or discrete logic circuitry, as well as any combinations of such components, or other devices. The term “processor” or “processing circuitry” may generally refer to any of the foregoing logic circuitry, alone or in combination with other logic circuitry, or any other equivalent circuitry.

Such hardware, software, and/or firmware may be implemented within the same device or within separate devices (e.g., within the system, outside of the system, or a combination of both) to support the various operations and functions described in this disclosure. In addition, any of the described components may be implemented together or separately as discrete but interoperable logic devices. Description of different features is intended to highlight different functional aspects and does not necessarily imply that such features must be realized by separate hardware or software components. Rather, functionality may be performed by separate hardware or software components, or integrated within common or separate hardware or software components.

When implemented in software, the functionality ascribed to the systems and methods described in this disclosure may be embodied as instructions and/or logic on a computer-readable medium such as RAM, ROM, NVRAM, EEPROM, FLASH memory, magnetic data storage media, optical data storage media, or the like. The instructions and/or logic may be executed by one or more processors to support one or more aspects of the functionality described in this disclosure.

Further, the compression garment system 10 may include a pump 103 that may be controlled by the controller 102 to provide a fluid to/from the one or more chambers of each of pressure applying regions, e.g., a fluid such as a liquid or gas in the chambers, of the exemplary garment 100 so as to apply a compression therapy when the compression garment 100 is donned by a user. For example, the pump 103 may be connected to one or more of the plurality of chambers corresponding to the plurality of pressure applying regions by a plurality of lines or tubing 105 so as to provide flow of fluid thereto or removal of fluid therefrom.

Further, in one or more embodiments, as shown in FIG. 1, the controller 102 may be connected to one or more components of the compression garment system via one or more electrical lines and/or wirelessly, as represented generally by dashed lines 104. For example, controller 102 may be connected to communicate and control the pressure applying regions (e.g., such as electrically actuatable pressure applying regions of the garment configured to apply pressure to the body) either with use of physical electrical connections and/or wirelessly.

The controllable pressure applying regions of the garment 100 under control of controller 102 may be described as allowing the system 10 to provide compression therapy to an individual (e.g., a patient) wearing the garment 100 such that lymph flows throughout the user's body in desired directions, e.g., such as from a user's arm distally to proximally to the user's torso to regions or areas underneath, or proximate, the user's arm pit and axillary nodes. In other words, by controlling the pressure applying regions in a variety of different sequences (e.g., applying pressure in a predetermined manner), for example, lymph may flow generally from the hand of a user's arm down the arm towards the user's torso underneath the user's arm pit near or proximate the axillary node. Additionally, the exemplary system 10 and garments described herein may be configured for use with a single arm or two arms, and further configured, to move lymph from one or both arms to one or both of the left and right axillary nodes.

The exemplary garment 100 may include a wraparound portion 110 and one or more additional garment portions 108, which, for example, are represented by a dashed-line box as shown in FIG. 1A. In this embodiment, the garment 100 may be described as including a single portion that may extend around the torso of a user, which in is the wraparound portion 110. In other embodiments, the garment 100 may include more than one portions that extend around the torso of a user. Additionally, the wraparound portion 110 may not be configured to extend around, or proximate, the neck of a user, e.g., to avoid any uncomfortableness about a user's neck. The one or more additional garment portions 108 may be coupled to the wraparound portion 110 as indicated by the double-sided dashed arrow. The one or more additional garment portions 108 may include an arm portion configured to be placed about a user's arm and/or a torso portion configured to be placed about a user's torso.

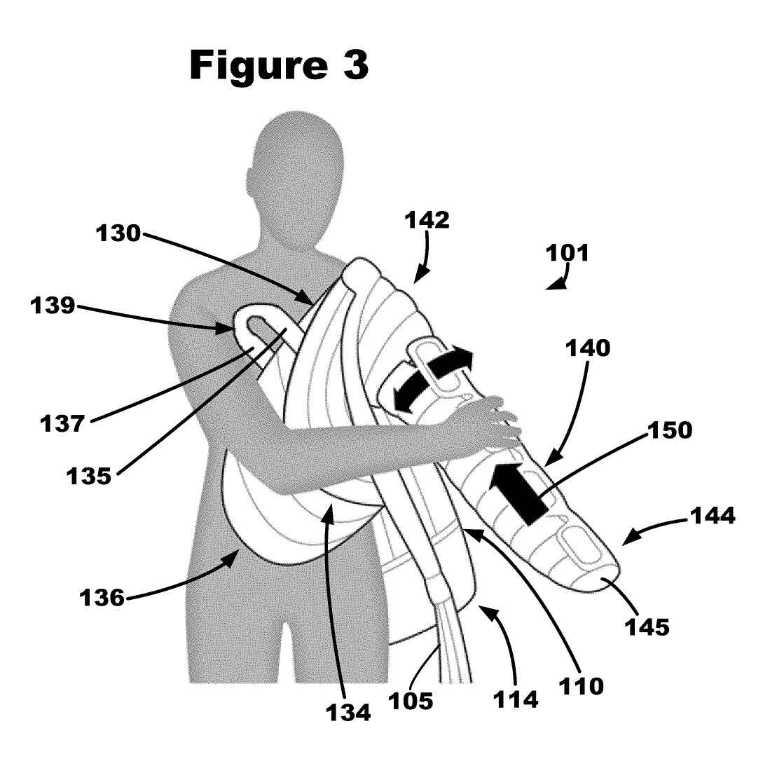

For example, an exemplary torso portion 130 is depicted as being coupled to the wraparound portion 110 in FIG. 1B. Further, for example, an exemplary arm portion and the torso portion 130 configured to be donned about a portion of a patient's body will be further described herein with respect to FIGS. 3-7. Generally, the torso portion 130 may be located over a user's shoulder such that a shoulder region 132 of the torso portion 130 is located proximate the user's shoulder and that a first region 134 may be coupled (e.g., removably coupled through hook-and-loop fasteners, etc.) to a second region 136 proximate a user's anterior and/or side torso region. As shown, in FIGS. 3-7 as will be described further herein, the first region 134 and the second region 136 may be coupled proximate the anterior, or front, torso of a user. The torso portion 130 may further include a first loop portion 135 extending from the first region 134 and a second loop portion 137 extending from the second region 136. The first and second loop portions 135, 137 may be coupled to each other (e.g., fixedly coupled such as sewed together, removably coupled such as using hook-and-loop fasteners, etc.) to provide a loop segment shown in FIG. 3, which may be grasped by a user's hand to assist inserting the user's opposite arm in another garment portion 108.

It is to be understood, however, from the embodiment in FIGS. 1A-1B that any type of garment and/or garment portions configured for use with a plurality of different types of therapy may be used with the wraparound portion 110.

The wraparound portion 110 may extend from a proximal end region 112 to a distal end region 114. The proximal end region 112 may be configured to be coupled to the one or more additional garment portions 108 including the torso portion 130. In one or more embodiments, the proximal end region 112 may be fixedly coupled to the one or more additional garment portions 108, e.g., through stitching, welding, adhesive, etc. In one or more other embodiments, the proximal end region 112 may be removably coupled to the one or more additional garment portions 108, e.g., through hook-and-loop fasteners, etc. In one or more embodiments, the wraparound portion 110, or regions or parts thereof, may be integral with the one or more additional garment portions 108.

The wraparound portion 110 may be generally described as being configured to be wrapped around a torso of a user to, e.g., secure or couple the exemplary garment 100 to or about the user's body. Further, it may be described that the wraparound portion 110 is configured to complete a circle or revolution around the user's body such that at least a portion including the wraparound portion 110 of the garment 100 extends around a user's body or portions thereof. Still further, the wraparound portion 110 may be configured to tighten one or more portions of the garment 100 about the torso of the user and position, or locate, the remaining garment portions about the user's body.

The wraparound portion 110 may include one or more pressure applying regions 111 as shown in FIG. 1A, which may be controlled by the controller 102 and pump 103 as described herein. In other embodiments, the wraparound portion 110 may not include pressure applying regions, and instead, may solely provide the functionality of securing the one or more additional garment portions 108, which may include one or more pressure applying regions, including the torso portion 130 to the torso of user's body.

As described herein, the wraparound portion 110 may extend from the proximal end region 112 to the distal end region 114. The wraparound portion 110 may be further described as terminating at the distal end region 114. In other words, the wraparound portion 110 may not extend past the distal end region 114. Wraparound portion 110 may include a mitt 120 located at, or proximate to, the distal end region 114. The mitt 120 may define, or include, a mitt opening 121 that is configured, or designed, to receive a hand of a user to assist the user in donning the garment 100 as will be described further herein with respect to FIGS. 3-7. In one or more embodiments, the mitt opening 121 may be defined by three closed sides and one open side. In other words, the mitt 120 may form a pocket, which may be referred to as the mitt opening 121. Further, in one or embodiments such as shown in the figures, a closed side of the mitt opening 121 may terminate the distal end region of the wraparound portion 110. In the embodiment depicted in the figures, a first portion of the mitt 120 may be part of the distal end region 114 of the wraparound portion 110 and a second portion of the mitt 120 may be attached, or coupled, (e.g. stitched, adhered, etc.) to the distal end region 114 of the wraparound portion 110 to create, or provide, the mitt 120 and mitt opening 121 (e.g., attached on three sides to provide one open side). It is to be understood that the mitt 120 and mitt opening 121, or pocket, may be formed in any manner. For example, the mitt 120, and thus, the mitt opening 121, may be created, or formed, by folding a portion of the wraparound portion 110 back onto itself and coupling the top and bottom edges to form a pocket, which is the mitt opening 121.

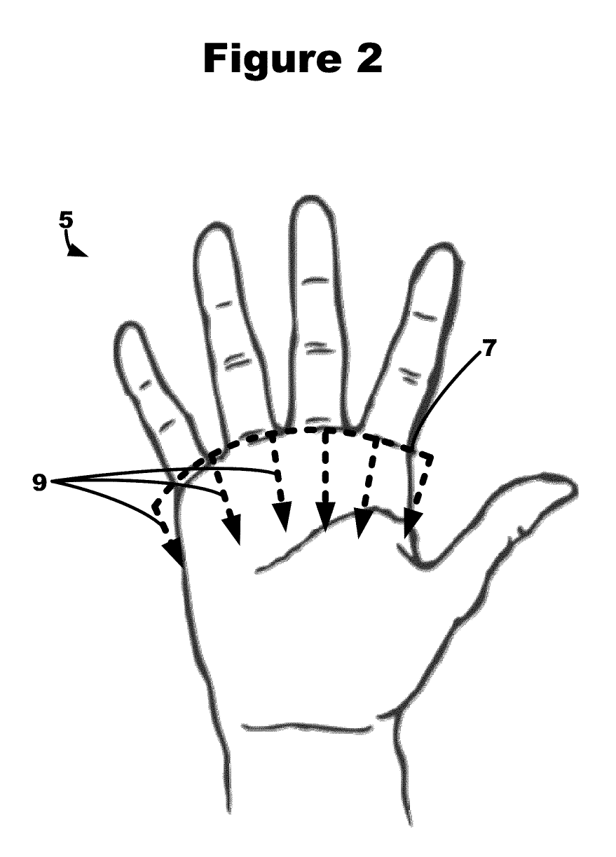

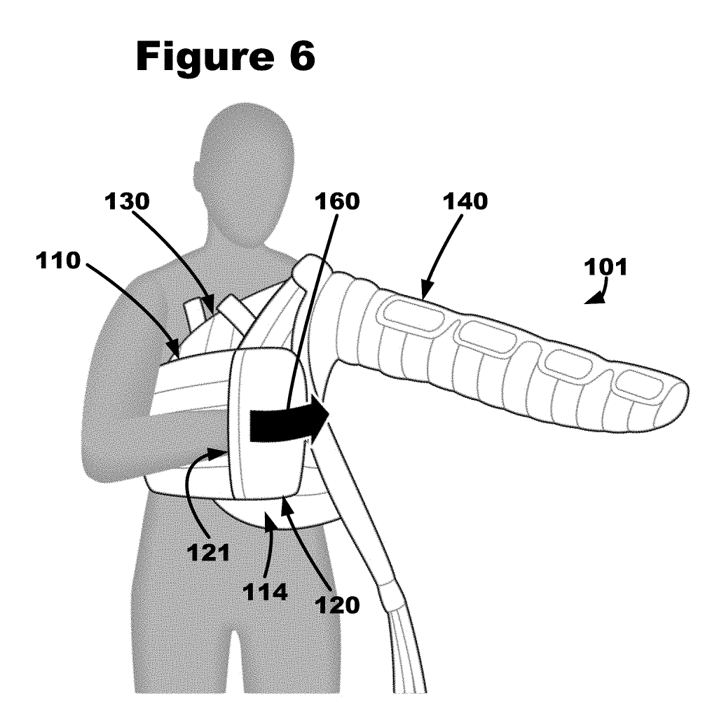

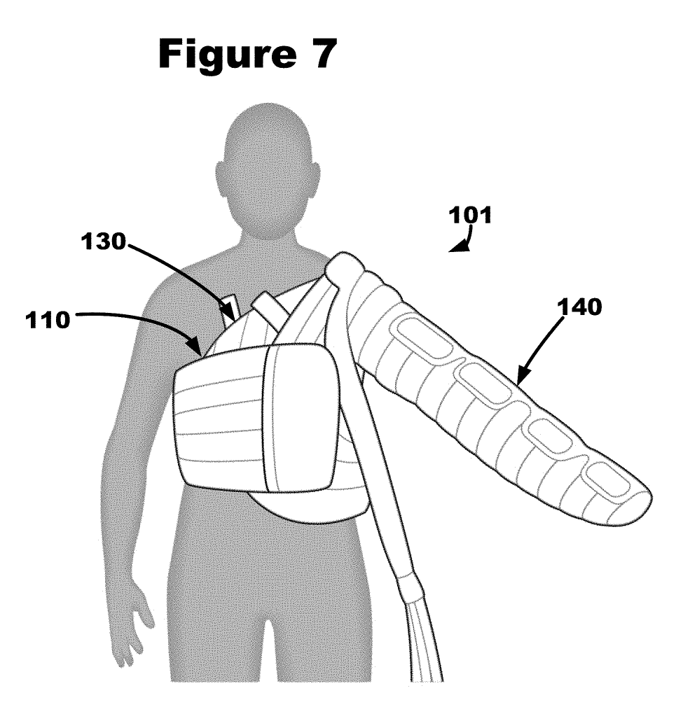

The mitt 120 as well the mitt opening 121 may be sized and constructed such that the mitt opening 121 is configured to receive more than the fingers, or a portion of the fingers, of a user's hand. In other words, the mitt opening 121 may define a pocket that is larger than a typical-human user's fingers so as to receive a typical human-user's hand or at least a majority of the user's hand. Further, the mitt opening 121 may be described in terms of a user's metacarpophalangeal joints (e.g., the joints between the phalangeal and metacarpal bones) as shown in FIG. 2. For example, the mitt opening 121 may be configured in size to receive, or hold, the index finger, the middle finger, the ring finger, the pinky, and at least a portion, or region, of a user's hand 5 beyond the metacarpophalangeal joint line 7 as indicated by the arrows 9. Still further, the mitt 120 may be configured such that the mitt opening 121 opens in a direction opposite the location of the arm portion 140 when the wraparound portion 110 is wrapped around the posterior torso region to the anterior torso region of the user as will be shown in FIGS. 6-7.

The size and configuration of the mitt 120 and the mitt opening 121 may provide any number of advantages. For example, the size of the mitt opening 121 may assist a user in locating, or placing, the user's hand in the mitt opening 121 when the mitt 120, and thus, the mitt opening 121, is located behind a user's back, or posterior, during donning such that, e.g., a user cannot, or may have trouble, seeing and/or reaching the mitt 120. Further, for example, the size of the mitt opening 121 may provide a large target for receiving a user's hand. Further, for example, the size of the mitt opening 121 may also allow a user to use their arm as opposed to just their fingers, or fingertips, to move the mitt 120, and thus, move the wraparound portion 110. Still further, for example, the size and configuration of the mitt 120 and the mitt opening 121 may allow variously-sized users including users having shorter arms or longer arms to reach the mitt opening 121 when donning the garment 100.

The one or more additional garment portions 108 may further include an arm portion configured to receive at least a portion of a user's arm to provide compression therapy to the arm. For example, the arm portion may define an arm opening to receive at least a portion of the arm of the user. An exemplary compression garment 101 including an arm portion 140 as well as a wraparound portion 110 and a torso portion 130 is shown in FIGS. 3-7 being donned by a user.

The arm portion 140 may extend from a proximal, or first, end region 142 to a distal, or second, end region 144, and the arm opening may extend from the proximal end region 142 to the distal end region 144 to receive the arm of the user. In this example, the left arm of the user is being received by the arm opening of the arm portion 140. The distal end region 144 of the arm portion 140 may be either open or closed. In this example the distal end region 144 defines a closed end 145 such that a user's hand, or at least a portion of user's hand such as one or more fingers, may not extend out of the distal end region 144 of the arm portion 140. In other embodiments, the distal end region 144 may define an open end such that a user's hand, or at least a portion of user's hand such as one or more fingers, may extend out of the distal end region 144 of the arm portion 140. The arm portion 140 may include, or define, a plurality of arm pressure-applying regions dispersed therein, or arranged thereabout, along the arm portion 140 from the distal end region 144 to the proximal end region 142, which as described herein, may be configured to move lymph in a direction from the distal, or second, end region 144 to the proximal, or first, end region 142 of the arm portion 140. The proximal end region 142 of the arm portion 140 may be coupled to the torso portion 130. In one or more embodiments, the proximal end region 142 of the arm portion 140 may be fixedly coupled to, or integral with, the torso portion 130 through stitching, welding, adhesive, etc. In one or more other embodiments, the proximal end portion 142 may be removably coupled to the torso portion 130, e.g., through hook-and-loop fasteners, etc. Additionally, in one or more embodiments, the arm portion 140 may be configurable to fit user's arms of various sizes in the arm opening. For example, as shown by the double-sided arrow of FIG. 3, the circumference of the arm opening of the arm portion 140 may be adjustable (e.g., through hook-and-loop fasteners, etc.).

When the garment 101 is fully, or completely, donned by a user, the distal end region 144 of the arm portion 140 may be located proximate a user's hand and the proximal end region 142 of the arm portion 140 may be located proximate user's armpit or shoulder. Further, the first region 134 of the torso portion 130 may be located proximate and possibly coupled to the second region 136 of the torso portion 130 to, e.g., encircle or loop around the user's arm. An exemplary donning process, or procedure, of the garment 101 will be illustrated in FIGS. 3-7. As shown in FIG. 3, a user has inserted their left arm into the arm opening of the arm portion 140 of the garment 101, grasped the region of the arm portion 140 between the distal end region 144 and the proximal end region 142 of the arm portion 140 with their right hand, and moved the arm portion 140 towards the armpit and/or shoulder region of the user to locate the arm portion 140 about their left arm as indicated by arrow 150. In other words, the user has slid their left arm down the arm opening of the arm portion 140 from the proximal end region 142 to the distal end region 144.

Further, the first loop portion 135 and the second loop portion 137 are coupled together as shown in FIG. 3 to form, or define, a loop segment 139. The loop segment 139 may be described as coupling the first region 134 to the second region 134 of the torso garment 130 to position the various regions and portions of the torso garment 130 so as to be donned by a user. For example, a user may grasp the loop segment 139 and then lift the exemplary compression garment 101 from a resting position (e.g., the exemplary compression 101 may be resting on a floor, on a table, in a box, etc.) prior to inserting their left arm in to the arm opening of the arm portion 140. In other words, a user may use the loop segment 139 to orient the compression garment 101 prior to donning. Additionally, as will be described further herein, a user may grasp the loop segment 139 to assist in inserting their left arm further into the arm opening of the arm portion 140. The loop segment 139, and portions 135, 137 thereof, may be include one or more materials such as, e.g., elastic materials, mesh materials, polymer materials, etc.

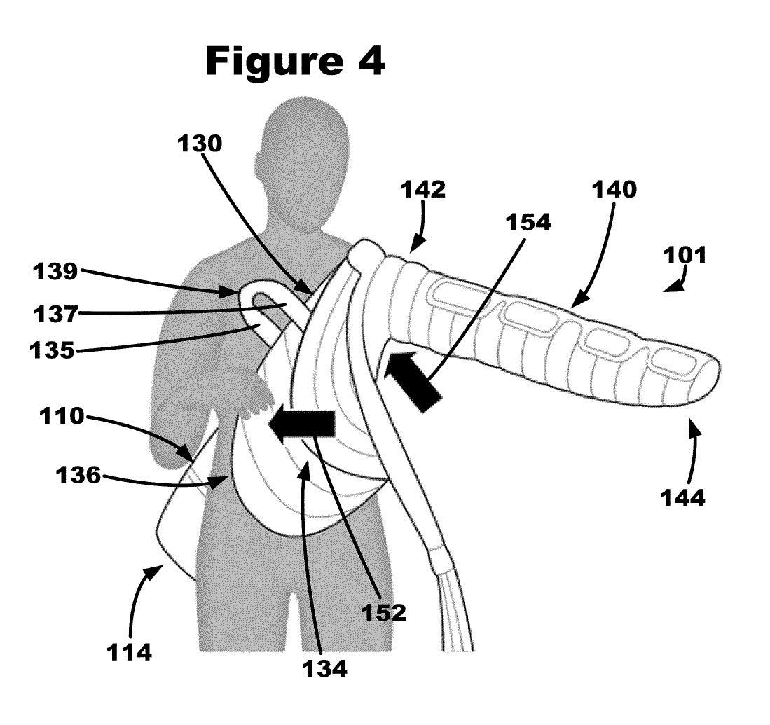

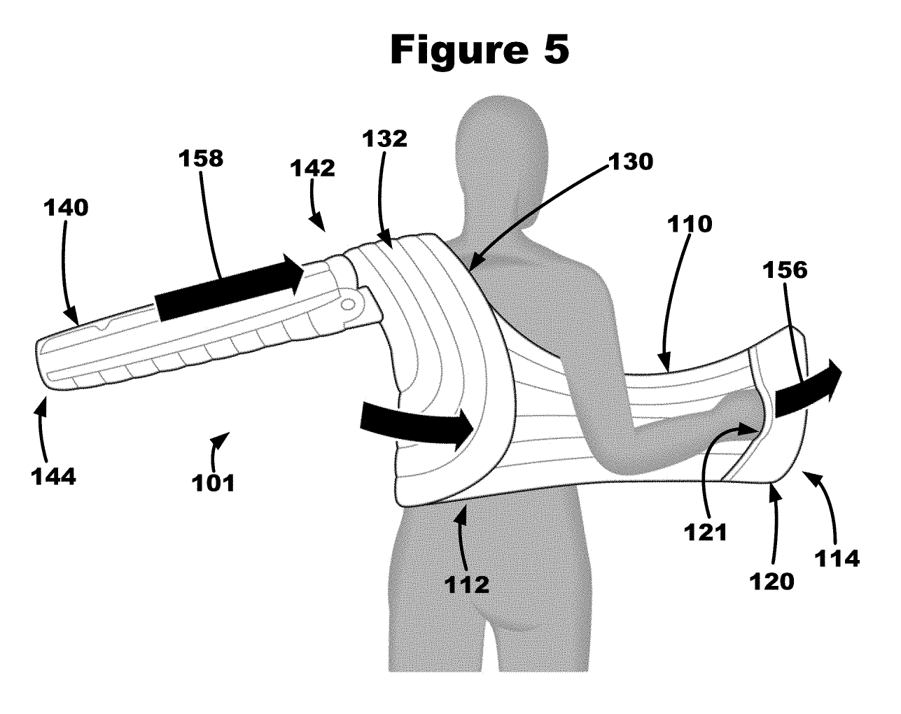

Next, as shown in FIG. 4, the user has grasped a portion of the second region 136 of the torso portion 130 and moved the portion away from their left arm as indicated by arrow 152 to assist in inserting their left arm further into the arm opening of the arm portion 140. In particular, this movement may move the proximal end region 142 of the arm portion 140 closer to the left armpit and/or shoulder of the user as indicated by arrow 154. In other words, the user may continue to slide the arm portion 140 onto their left arm. Further, although not shown, a user may grasp the loop segment 139 and move the segment 139 away from their left arm to also assist in inserting their left arm further into the arm opening of the arm portion 140. The loop segment 139 may provide a convenient grasping location on the torso portion 130 for the user. Still further, although the first and second loop portions 135, 137 are not shown in the remaining FIGS. 5-7 being coupled to one another to form, or define, the loop segment 139, it is to be understood that the loop segment 139 may be included in some embodiments and may not be included in other embodiments.

As can be seen in FIG. 4, the distal end region 114 of the wraparound portion 110 may be located in a low posterior location behind the user such that, e.g., the distal end region 114 may be difficult, or challenging, to locate, grasp, and then to move, or wrap, the wraparound portion 110 about the right side of the user's torso and across the anterior side of user's torso over the second region 136 of the torso portion 130 of garment 101. Further, the distal end region 114 of the wraparound portion 110 may be described as being located in awkward position for a human user to grasp (e.g., behind or partially-behind the user's back, hanging below the user's waistline, etc.).

The user may reach their right arm behind their body, or wherever the distal end region 114 and mitt opening 121 is located, to the distal end region 114 of the wraparound portion 110 and insert their right hand into the mitt opening 121 of the mitt 120 of the wraparound portion 110, and then, move their right hand and arm in a direction away from the left arm as indicated by arrow 156 in FIG. 5. As shown, this movement away from the left arm may further assist in inserting the left arm into the arm opening of the arm portion 140 as indicated by arrow 158. In other words, this movement and functionality shown in FIG. 5 may further slide the user's left arm down the arm opening of the arm portion 140. Further, as shown, more than just the fingers of the user's right hand are located in, or received within, the mitt opening 121 of the mitt 120 of the wraparound portion 110 due to, e.g., the size and/or configuration of the mitt 120.

Once the user's left arm is fully, or completely, inserted into the arm opening of the arm portion 140 using the movement depicted in FIG. 5, the user may move their right hand, and thus, right arm, across the anterior torso region of the user to wrap the wraparound portion 110 around the posterior torso region to the anterior torso region of the user as shown in FIG. 6. The user may further tighten the wraparound portion 110 about the user's torso by moving the distal end region 114 of the wraparound portion 110 in a direction towards the left arm as indicated by arrow 160. This movement of the wraparound portion 110 may tighten the torso portion 140 and/or wraparound portion 110 about the torso to, e.g., provide a snug fit, position the remaining garment portions about the user's body, etc. The distal end region 114 of the wraparound portion 110 may then be coupled, or secured, (e.g., removably coupled through hook-and-loop fasteners, etc.) to the torso portion 130 about the anterior of the user. In at least one embodiment, the inner, or inside, surface (e.g., the surface facing the user) of the distal end region 114 of the wraparound portion 110 may include hook-and-loop fasteners that are configured to be removably couplable to an outer, or outside, surface (e.g., the surface facing away from the user) of the torso portion 130.

In at least one embodiment, the garment 101, or portions/regions thereof, may include an exterior facing layer, or the layer defining the exterior surface, defined by, or including, one or more fabric materials so as to define a “loop” surface on the exterior surface for coupling to a “hook” surface or material. For example, the exterior surface of the exemplary garment 101 may be described as being either partially or completely defined by a “loop” surface for use in a “hook-and-loop” fastener. The distal end region 114 of the wraparound portion 110 may define a “hook” surface on the interior surface so as to facilitate removable coupling to the exterior “loop” surface of the torso portion 130.

As shown in FIG. 7, the user has finished donning the garment 101 and may begin compression therapy to, e.g., move lymph. Further, the garment 101 may be described as including a single portion, which is the wraparound portion 110, extending around the torso of the user when fully, or completed, donned. Additionally, the garment 101 may be described as not including garment portions that extend around, or proximate, the shoulder or neck region opposite the arm being located in the arm portion 140. For example, the user's right shoulder and right neck area (as well as anterior and posterior neck areas) are “free” from garment portions extend thereabout, which, e.g., may avoid any comfort issues about those area. Still further, after the wraparound portion 110 is coupled to the torso portion 130, the wraparound portion 110 may be further tightened using various tightening apparatus that may be similar to and may include one or more features found in PCT International Application No. PCT/US2015/036951 entitled “Compression Garment System with Tightening Apparatus,” which is herein incorporated by reference in its entirety. For example, a length of the wraparound portion 110 may be adjusted using such exemplary tightening apparatus.

Unless otherwise indicated, all numbers expressing feature sizes, amounts, and physical properties used in the specification and claims are to be understood as being modified in all instances by the term “about.” Particular materials and dimensions thereof recited in the disclosed examples, as well as other conditions and details, should not be construed to unduly limit this disclosure. Although the subject matter has been described in language specific to structural features and/or methodological acts, it is to be understood that the subject matter defined in the appended claims is not necessarily limited to the specific features or acts described above. Rather, the specific features and acts described above are disclosed as representative forms of implementing the claims.

What is claimed is:

1. A method of donning a compression garment on a user:
providing a compression garment comprising:
an arm portion defining an arm opening to receive at least a portion of a first arm of a user to apply compression to the first arm, and
a wraparound portion extending from a proximal end region coupled to the arm portion and terminating a distal end region, wherein the wraparound portion comprises a mitt at distal end region defining a mitt opening to receive a hand of a second arm of the user to assist the user in inserting the first arm into the arm opening of the arm portion and in wrapping the wraparound portion around a posterior torso region to an anterior torso region of the user;
inserting the first arm of the user into the arm opening of the arm portion of the compression garment;
inserting the hand of the second arm of the user into the mitt opening of the mitt portion;
moving, when the hand of the second arm is inserted into the mitt opening, the hand of the second arm of the user in a direction away from the first arm to assist in inserting the first arm further into the arm opening of the arm portion; and
moving, when the hand of the second arm is inserted into the mitt opening, the hand of the second arm of the user across the anterior torso region of the user to wrap the wraparound portion around the posterior torso region to the anterior torso region of the user.

2. The method of claim 1, wherein the mitt opening is sized to receive more than the fingers of the hand of the second arm of the user.

3. The method of claim 1, wherein the mitt opening opens in a direction opposite the location of the arm portion when the wraparound portion is wrapped around the posterior torso region to the anterior torso region of the user.

4. The method of claim 1, wherein the compression garment further comprises a torso portion coupled to the proximal end region of the wraparound portion and coupled to the arm portion.

5. The method of claim 4, wherein the distal end region of the wraparound portion is removably couplable to the torso portion of the compression garment.

6. The method of claim 4, wherein the distal end region of the wraparound portion is removably couplable to the torso portion of the compression garment using hook-and-loop fasteners.

7. The method of claim 4, wherein the torso portion comprises a plurality of pressure applying regions to apply pressure to a plurality of torso regions of the torso of the user when the compression garment is donned to assist in moving lymph from the torso to one or more axillary nodes.

8. The method of claim 4, wherein the torso portion is configured to be grasped by the hand of the second arm of the user to assist inserting the first arm into the arm opening of the arm portion prior to the use of the mitt opening to assist in inserting the first arm further into the arm opening of the arm portion.

9. The method of claim 4, wherein the torso portion comprises a loop segment that is configured to be grasped by the hand of the second arm of the user to assist inserting the first arm into the arm opening of the arm portion prior to the use of the mitt opening to assist in inserting the first arm further into the arm opening of the arm portion.

10. The method of claim 1, wherein the arm portion extends from a first end region to a second region coupled to the wraparound around portion, wherein the first end region is configured to be located proximate the arm pit of the first arm and the second end region is configured to be located proximate the hand of the first arm when the compression garment is donned.

11. The method of claim 10, wherein the arm portion defines a plurality of arm pressure applying regions positioned along the arm portion from first end region to the second region to apply pressure to a plurality of arm regions of the first arm to assist in moving lymph from the first arm to one or more axillary nodes when the compression garment is donned.

12. The method of claim 11, wherein the arm portion of the compression garment comprises a plurality of cells corresponding to the plurality of arm pressure applying regions and configured to receive fluid to apply pressure to the plurality of regions of the first arm when the compression garment is donned.

13. The method of claim 1, wherein the wraparound portion of the garment further comprises a plurality of pressure applying regions to apply pressure to a plurality of torso regions of the torso of the user to move lymph from the torso to one or more axillary nodes.

14. A compression garment comprising:
an arm portion defining an arm opening to receive at least a portion of a first arm of a user to apply compression to the first arm; and
a wraparound portion extending from a proximal end region coupled to the arm portion and terminating a distal end region, wherein the wraparound portion comprises a mitt at distal end region defining a mitt opening to receive a hand of a second arm of the user to assist the user in inserting the first arm into the arm opening of the arm portion and in wrapping the wraparound portion around a posterior torso region to an anterior torso region of the user.

15. The garment of claim 14, wherein the mitt opening is sized to receive more than the fingers of the hand of the second arm of the user.

16. The garment of claim 14, wherein the mitt opening opens in a direction opposite the location of the arm portion when the wraparound portion is wrapped around the posterior torso region to the anterior torso region of the user.

17. The garment of claim 14, wherein the compression garment further comprises a torso portion coupled to the proximal end region of the wraparound portion and coupled to the arm portion.

18. The garment of claim 17, wherein the distal end region of the wraparound portion is removably couplable to the torso portion of the compression garment.

19. The garment of claim 17, wherein the distal end region of the wraparound portion is removably couplable to the torso portion of the compression garment using hook-and-loop fasteners.

20. The garment of claim 17, wherein the torso portion comprises a plurality of pressure applying regions to apply pressure to a plurality of torso regions of the torso of the user when the compression garment is donned to assist in moving lymph from the torso to one or more axillary nodes.

21. The garment of claim 17, wherein the torso portion is configured to be grasped by the hand of the second arm of the user to assist inserting the first arm into the arm opening of the arm portion prior to the use of the mitt opening to assist in inserting the first arm further into the arm opening of the arm portion.

22. The garment of claim 17, wherein the torso portion comprises a loop segment that is configured to be grasped by the hand of the second arm of the user to assist inserting the first arm into the arm opening of the arm portion prior to the use of the mitt opening to assist in inserting the first arm further into the arm opening of the arm portion.

23. The garment of claim 14, wherein the arm portion extends from a first end region to a second region coupled to the wraparound around portion, wherein the first end region is configured to be located proximate the arm pit of the first arm and the second end region is configured to be located proximate the hand of the first arm when the compression garment is donned.

24. The garment of claim 23, wherein the arm portion defines a plurality of arm pressure applying regions positioned along the arm portion from first end region to the second region to apply pressure to a plurality of arm regions of the first arm to assist in moving lymph from the first arm to one or more axillary nodes when the compression garment is donned.

25. The garment of claim 24, wherein the arm portion of the compression garment comprises a plurality of cells corresponding to the plurality of arm pressure applying regions and configured to receive fluid to apply pressure to the plurality of regions of the first arm when the compression garment is donned.

26. The garment of claim 14, wherein the wraparound portion of the garment further comprises a plurality of pressure applying regions to apply pressure to a plurality of torso regions of the torso of the user to move lymph from the torso to one or more axillary nodes.
